(19) United States
(12) Patent Application Publication
(10) Pub. No.: US 2014/0115460 A1
(43) Pub. Date: Apr. 24, 2014

(54) Importing Media Content

(71) Applicant: APPLE INC., Cupertino, CA (US)

(72) Inventors: Nils Angquist, San Francisco, CA (US); Colleen M. Pendergast, Livermore, CA (US); Sean Perkins, New York, NY (US); Satoshi Yamamoto, Sunnyvale, CA (US)

(73) Assignee: Apple Inc., Cupertino, CA (US)

(21) Appl. No.: 13/656,313

(22) Filed: Oct. 19, 2012

(51) Int. Cl. G06F 3/048

(52) U.S. Cl. CPC G06F 3/048
USPC 715/716

(57) ABSTRACT

Among other things, a method includes displaying, in a user interface of a media authoring application, an interface enabling a user of the media authoring application to import media content from any media source supported by the media authoring application, wherein at least one of the media sources is a media capture device and at least one of the media sources is a portion of a file system of a storage device, the interface including a pane displaying a list of media sources currently available to the media authoring application, a pane displaying a list of media content files available at a selected media source, and a pane displaying at least a portion of a selected media content file.

### TECHNICAL FIELD

The disclosure generally relates to importing media content, e.g., in a media authoring application.

### BACKGROUND

Media content, for example, images, audio, and video, can be imported into (e.g., received by) a media authoring application (e.g., image editor, video editor, sound editor). The media content can then be presented in a user interface and manipulated. Media content may be imported from any one of several kinds of media sources.

### SUMMARY

In one aspect, in general, a method includes displaying, in a user interface of a media authoring application, an interface enabling a user of the media authoring application to import media content from any media source supported by the media authoring application, wherein at least one of the media sources is a media capture device and at least one of the media sources is a portion of a file system of a storage device, the interface including a pane displaying a list of media sources currently available to the media authoring application, a pane displaying a list of media content files available at a selected media source, and a pane displaying at least a portion of a selected media content file.

Implementations may include one or more of the following features. The portion of the selected media content file is a single frame of a video clip. The portion of the selected media content file is a series of frames of a video clip. The pane displaying the list of media content files displays metadata representing media characteristics of at least some of the media content files. The media characteristics of at least some of the media content files are derived from the content of the media content files. A selection of a portion of a file system is received from a user of the media authoring application of a storage device, and it is determined, based on characteristics of data files of the portion of the file system, if the portion of the file system contains media content supported by the media authoring application. At least some of the media sources supported by the media authoring application are each associated with configuration data used by the media authoring application to access the respective media source.

Other aspects may include corresponding systems, apparatus, or computer readable media.

Details of one or more implementations are set forth in the accompanying drawings and the description below. Other features, aspects, and potential advantages will be apparent from the description and drawings, and from the claims.

### DESCRIPTION OF DRAWINGS

FIG. 1 shows a media authoring application being operated by a user of a computer system.

FIG. 2 shows an example user interface of the media authoring application.

FIG. 3 shows another view of the user interface of the media authoring application.

FIG. 4 is a flowchart of an exemplary process of enabling a user to import media content from a variety of media sources.

FIG. 5 is a block diagram of an exemplary system architecture implementing the features and processes of FIGS. 1-4.

Like reference symbols in the various drawings indicate like elements.

### DETAILED DESCRIPTION

A media authoring application (e.g., video editing software) may be capable of importing media content (e.g., video clips) from more than one type of source. For example, media authoring application could allow users to import media content from a camera, and also import media content from files on a computer's hard drive. Rather than provide different interfaces for different types of sources, the media authoring application can provide a single interface that allows a user to select any source supported by the application and choose what content to import.

The single interface can display a list of available sources, and when a given source is selected, display a list of media files, including metadata about the media files. When one of the media file is selected, a portion of the content of the file can be displayed (e.g., a frame of a video clip, or a filmstrip representation of the video clip).

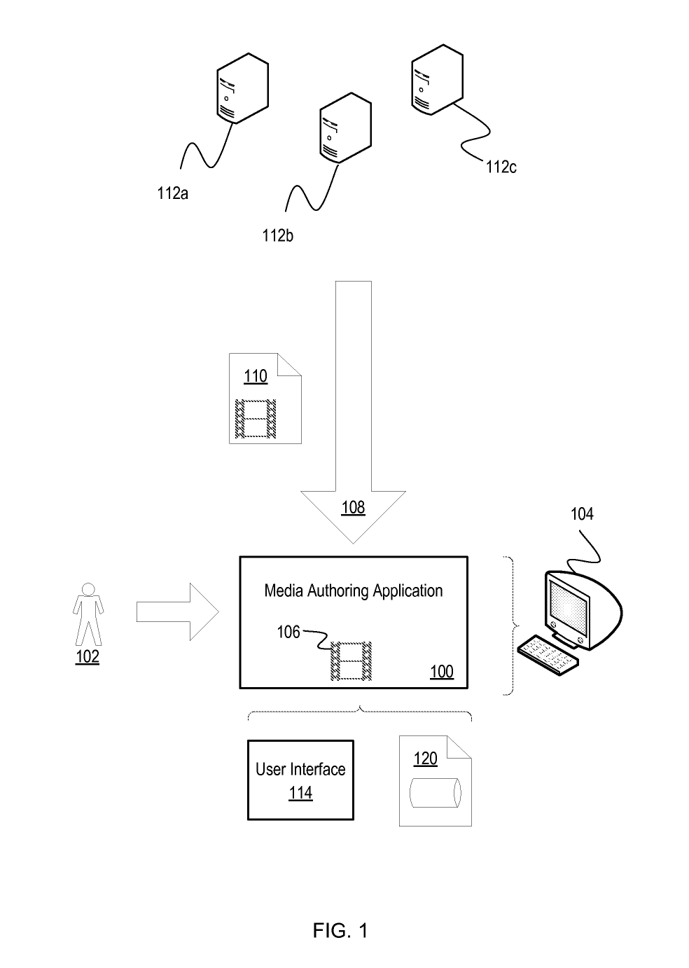

FIG. 1 shows a media authoring application 100 being operated by a user 102 of a computer system 104. The media authoring application 100 enables the user 102 to author media content 106, for example, audio, video, still images, or any combination of these or other media. The media authoring application 100 also enables the user 102 to import 108 the media content 106 from media sources 112a-c. Media content 106 can be received from the media sources 112a-c in the form of media files 110.

The media authoring application 100 can provide a single user interface 114 that can be used to import 108 media files 110 from any of the media sources 112a-c. For example, one media source 112a may be a media capture device (e.g., a digital camera or camcorder) in communication with the computer system 104, and another media source 112b may be a storage medium (e.g., a solid-state card) accessible to the computer system 104, and another media source 112c may be a file system (e.g., data stored on a disk drive) maintained by the computer system 104. The single user interface 114 can provide the user 102 with access to information about the media files 110 usable to identify the content of the respective media files 110, regardless of the media source 112a-c from which a media file 110 is received from. The media source 112a-c need only be supported by the media authoring application 100. A media source 112a-c is supported by the media authoring application 100 if the media authoring application 100 has access to configuration data 120 specific to a type of media source. For example, if a media source is a storage medium having a particular data format, the media authoring application 100 may be provided configuration data about the data format. If a media source is a media capture device, the media authoring application 100 may be provided configuration data indicating how to receive data (e.g., using which communication protocols) from the media capture device. The configuration data 120 could be provided by the user 102 (e.g., in the form of a configuration file or “plug-in” containing configuration data), or the configuration data 120 could be received from an operating system of the computer system 104, or the configuration data 120 could be received from another source.

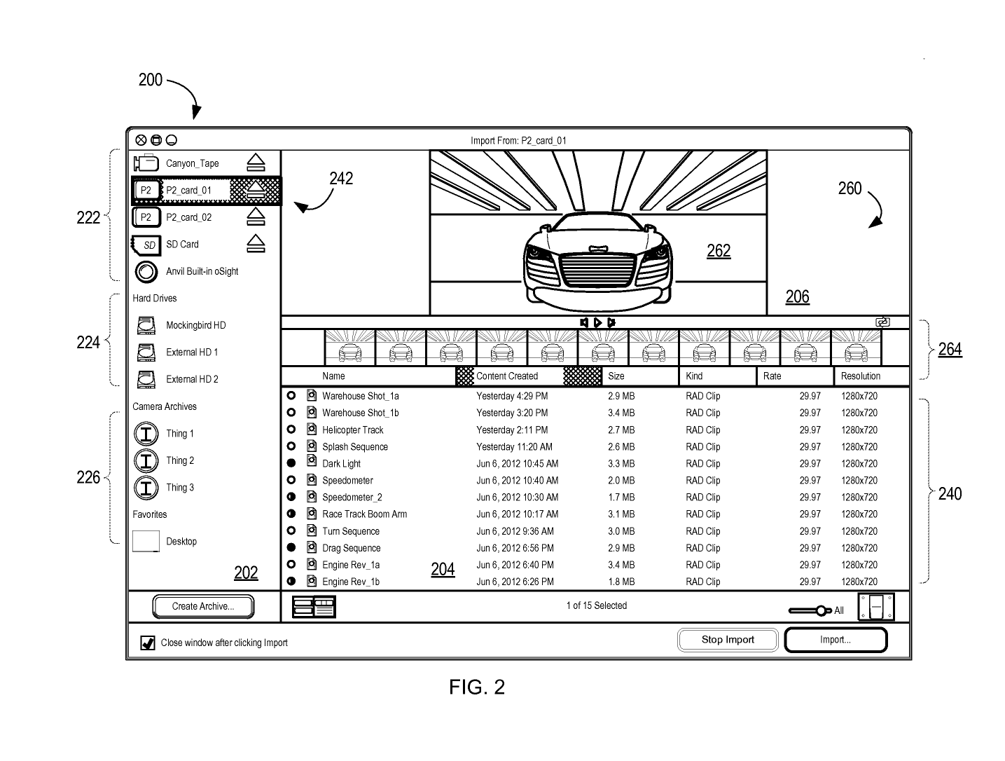

FIG. 2 shows an example user interface 200 of the media authoring application 100 (FIG. 1). The user interface 200 enables media content to be imported from any media source supported by the media authoring application. The user interface 200 includes a media source pane 202, a media file pane 204, and a media preview pane 206.

The media source pane 202 displays a list of media sources 220 available to the media authoring application. The media source pane 202 is capable of providing access to any media source supported by the media authoring application 100. The list of media sources 220 includes external devices 222, which include media capture devices such as cameras, as well as storage media such as solid-state cards. Generally, the media sources 220 may store primarily media files, but also could store other types of data. In some examples, the external devices 222 may be autonomous devices, e.g., a media capture device which operates and stores data independently of the computer system 104 running the media authoring application 100. In some examples, the external devices 222 may be maintained by a device other than the computer system 104 running the media authoring application 100, e.g., storage media formatted for a media capture device rather than formatted for the computer system. In some examples, the external devices may be in physical communication with a computer system 104 running the media authoring application 100 (e.g., they may be connected by wires, inserted into media slots, etc.). In some examples, the external devices may be accessible to the computer system 104 in another way, e.g., accessible using wireless communication, accessible using a network, accessible using a “cloud” communication technique, etc.

The list of media sources 220 also includes local sources 224. Local devices 224 can include storage media maintained by the computer system 104, e.g., storage media formatted for use with the computer system 104 and/or having a file system chosen for use with an operating system running on the computer system 104. In some examples, the local sources 224 are not physical media such as disks, but rather logical media such as partitions of a disk, or file folders or other data structures. While the external devices 222 may store primarily media files, the local sources 224 may store primarily other types of data, e.g., an operating system of the computer system 104, applications for execution by the computer system 104, and data usable by applications other than the media authoring application 100.

In some implementations, one of the media sources 200 provides media content in one or more media formats. In some examples, the media authoring application 100 (FIG. 1) may support a particular media format if the media authoring application 100 has been provided with a functional component (e.g., containing a portion of the configuration data 120 shown in FIG. 1) for manipulating the particular media format. For example, the functional component could be a codec (coder/decoder) which is used to read or write media content (e.g., video data) of a particular format. In some examples, a codec is provided as a standalone functional component (e.g., a standalone data file, “plug-in,” or other kind of functional component). In some examples, a codec is provided as part of another functional component for reading and writing data from a particular source. For example, a single “plug-in” may provide the media authoring application 100 with functionality for accessing a particular kind of media source (e.g., a particular kind of storage device) as well as a particular format of media content (e.g., video content encoded using a particular kind of codec). In some implementations, a “plug-in” could also provide access to data received using a particular kind of network protocol or data stored on a particular kind of file system.

The media file pane 204 displays a list of media files 240 available at (e.g., stored by) the selected media source 242. The list of media files 240 can be displayed for any media source in the list of media sources 220. In some implementations, the list of media files 240 includes metadata 244 describing characteristics of each media file. Metadata 244 can include a title of the media content, date and time when the media content was created or modified, file size, file format, and other characteristics of the media file. In some implementations, the metadata 244 can be extracted from each respective media file. For example, the media authoring application 100 may be configured to parse one or more types of media files (e.g., media files of a particular data format, or media files received from a particular kind of media source) to extract the metadata 244 displayed in the user interface 200. In some implementations, the metadata 244 is extracted from a separate data file associated with the media file (e.g., stored in the same directory as the media file).

A user of the user interface 200 can select any of the media files in the list of media files 240 to import them to the media authoring application 100 (e.g., using an import button). Media files 240 are displayed in the media file pane 204 regardless of the type of media source selected in the media source pane 202. Put another way, the media file pane 204 can be used to display contents of any type of media source supported by the media authoring application 100.

The media preview pane 206 displays a preview 260 of the media content of a media file selected in the media file pane 204. The preview 260 could be, for example, a thumbnail of an image file, a visualization of an audio file, or a portion of a video clip. In the example shown, the selected media source 242 is a video clip. The preview 260 includes a single frame 262 of a video clip and also includes a series of frames 264 of the video clip, sometimes referred to as a “filmstrip” view. The series of frames 264 enables a user to view portions of the video clip in a static form, rather than play the video clip to see its contents. The user can change the single frame 262 shown by selecting a particular point in the series of frames 264. The single frame 262 displayed will correspond to the frame of video content located chronologically in the video content represented by the series of frames 264. The single frame 262 then displayed may not correspond to a frame displayed as part of the series of frames 264, since the series of frames 264 represents only a subset of the frames of video content of the corresponding video clip. In some implementations, the user can move a cursor or indicator (e.g., by “dragging” the cursor or indicator using an input device such as a mouse or touchscreen) across the series of frames 264. The single frame 262 displayed will be updated in real time as the cursor or indicator moves across the series of frames 264.

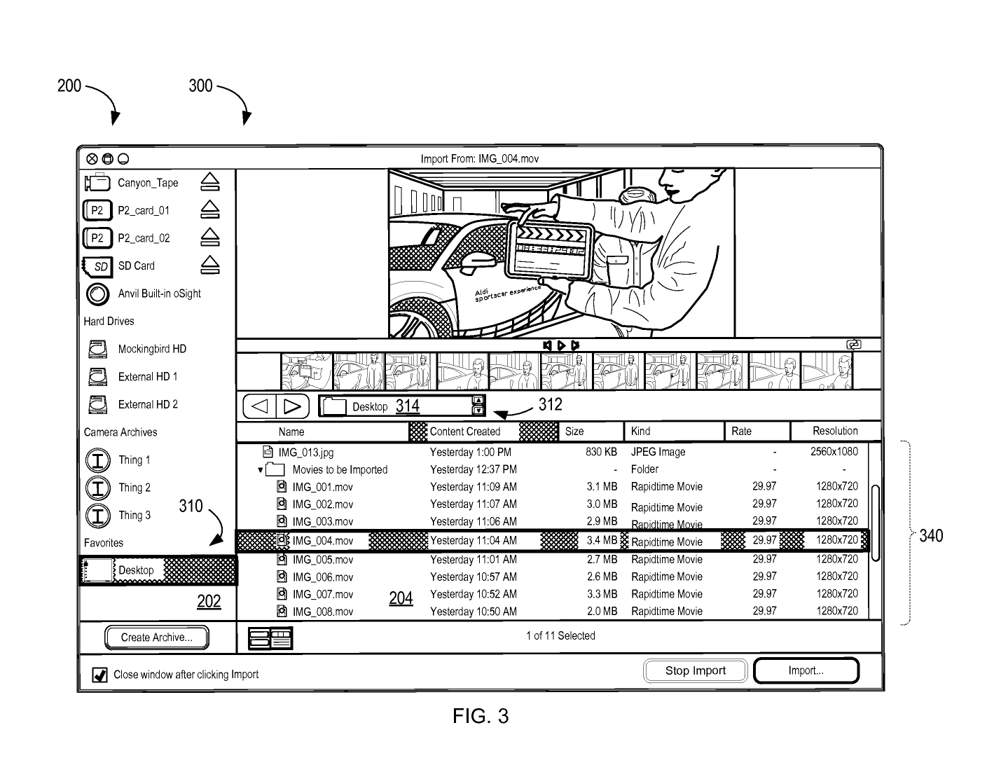

FIG. 3 shows another view 300 of the user interface 200. In this view, the user has selected a favorites option 310 in the media source pane 202. The favorites option 310 enables a user to access sources of media content that the user has marked for later recall as favorite. In the example shown, the selected favorite source 312 is a file folder 314 (“Desktop”) made available by a file system maintained by the operating system of the computer system 104 running the media authoring application 100. The user could choose other favorites corresponding to other file folders, storage media, or other media sources.

In the examiner shown, the file folder 314 contains video files 340 as displayed in the media file pane 204. The video files 340 are determined to contain video content by the media authoring application 100. For example, the media authoring application 100 can examine data representing the contents of the file folder 314 to determine file types of files in the file folder 314. The media authoring application 100 may make this determination based on filename extensions of the files, or metadata stored with the files, or patterns in the data of the files (e.g., patterns representative of frames of video or portions of audio encoded using a particular codec, for example). In some implementations, the media file pane 204 only displays files of a type relevant to the media authoring application 100, for example, video files. In some examples, the media file pane 204 may display files of multiple types, for example, video files and still image files. In some implementations, a file folder 314 is only available for display in the user interface 200 if the file folder 314 has been determined to contain media files of a type supported by the media authoring application 100 (e.g., media files that can be viewed and/or manipulated in the media authoring application 100, such as media files readable using a codec provided to the media authoring application 100).

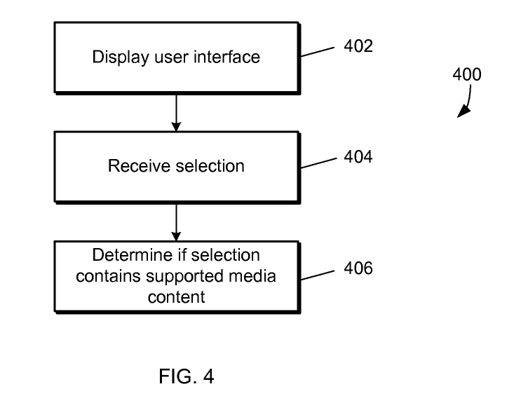

FIG. 4 is a flowchart of an exemplary process 400 of enabling a user to import media content from a variety of media sources. The process 400 can be performed, for example, by the computer system 104 shown in FIG. 1. The process 400 displays 402, in a user interface of a media authoring application, an interface enabling a user of the media authoring application to import media content. The media content can be imported from any media source supported by the media authoring application. Some or all of the media sources supported by the media authoring application may be each associated with configuration data used by the media authoring application to access the respective media source. For example, at least one of the media sources is a media capture device and at least one of the media sources is a portion of a file system of a storage device. The interface includes a pane displaying a list of media sources currently available to the media authoring application. The interface also includes a pane displaying a list of media content files available at a selected media source. The pane displaying the list of media content files could display metadata representing media characteristics of at least some of the media content files. For example, the media characteristics of at least some of the media content files could be derived from the content of the media content files. The interface also includes a pane displaying at least a portion of a selected media content file. In some examples, the portion of the selected media content file could be a single frame of a video clip. In some examples, the portion of the selected media content file could be a series of frames of a video clip. In some implementations, the process 400 receives 404, from a user of the media authoring application, a selection of a portion of a file system of a storage device. The process 400 may also determine 406, based on characteristics of data files of the portion of the file system, if the portion of the file system contains media content supported by the media authoring application.

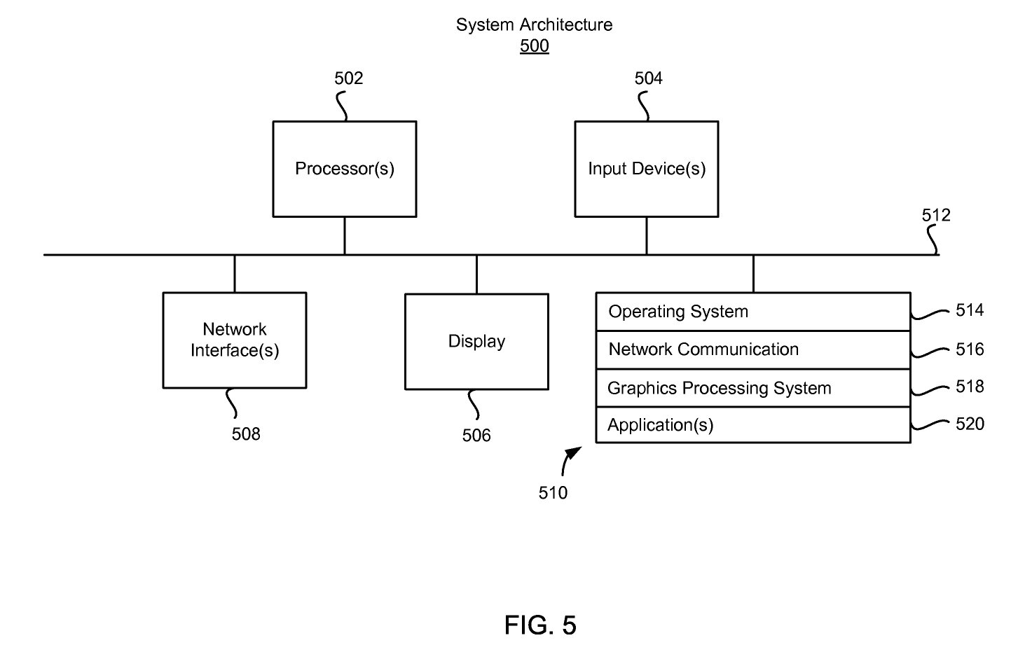

FIG. 5 is a block diagram of an exemplary system architecture implementing the features and processes of FIGS. 1-4. The architecture 500 can be implemented on any electronic device that runs software applications derived from compiled instructions, including without limitation personal computers, servers, smart phones, media players, electronic tablets, game consoles, email devices, etc. In some implementations, the architecture 500 can include one or more processors 502, one or more input devices 504, one or more display devices 506, one or more network interfaces 508 and one or more computer-readable mediums 510. Each of these components can be coupled by bus 512.

Display device 506 can be any known display technology, including but not limited to display devices using Liquid Crystal Display (LCD) or Light Emitting Diode (LED) technology. Processor(s) 502 can use any known processor technology, including but are not limited to graphics processors and multi-core processors.

Input device 504 can be any known input device technology, including but not limited to a keyboard (including a virtual keyboard), mouse, track ball, and touch-sensitive pad or display. In some implementations, the input device 504 could include a microphone 530 that facilitates voice-enabled functions, such as speech-to-text, speaker recognition, voice replication, digital recording, and telephony functions. The input device 504 can be configured to facilitate processing voice commands, voiceprinting and voice authentication. In some implementations, audio recorded by the input device 504 is transmitted to an external resource for processing. For example, voice commands recorded by the input device 504 may be transmitted to a network resource such as a network server which performs voice recognition on the voice commands.

Bus 512 can be any known internal or external bus technology, including but not limited to ISA, EISA, PCI, PCI Express, NuBus, USB, Serial ATA or FireWire. Computer-readable medium 510 can be any medium that participates in providing instructions to processor(s) 502 for execution, including without limitation, non-volatile storage media (e.g., optical disks, magnetic disks, flash drives, etc.) or volatile media (e.g., SDRAM, ROM, etc.).

Computer-readable medium 510 can include various instructions 514 for implementing an operating system (e.g., Mac OS®, Windows®, Linux). The operating system can be multi-user, multiprocessing, multitasking, multithreading, real-time and the like. The operating system performs basic tasks, including but not limited to: recognizing input from input device 504; sending output to display device 506; keeping track of files and directories on computer-readable medium 510; controlling peripheral devices (e.g., disk drives, printers, etc.) which can be controlled directly or through an I/O controller; and managing traffic on bus 512. Network communications instructions 516 can establish and maintain network connections (e.g., software for implementing communication protocols, such as TCP/IP, HTTP, Ethernet, etc.).

A graphics processing system 518 can include instructions that provide graphics and image processing capabilities. For example, the graphics processing system 518 can implement the processes described with reference to FIGS. 1-4.

Application(s) 520 can be an application that uses or implements the processes described in reference to FIGS. 1-4. For example, the applications 520 could include the media authoring application 100 shown in FIG. 1. The processes can also be implemented in operating system 514.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an API. An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A method comprising:
displaying, in a user interface of a media authoring application, an interface enabling a user of the media authoring application to import media content from any media source supported by the media authoring application, wherein at least one of the media sources is a media capture device and at least one of the media sources is a portion of a file system of a storage device, the interface including
a pane displaying a list of media sources currently available to the media authoring application,
a pane displaying a list of media content files available at a selected media source, and
a pane displaying at least a portion of a selected media content file.

2. The method of claim 1, wherein the portion of the selected media content file is a single frame of a video clip.

3. The method of claim 1, wherein the portion of the selected media content file is a series of frames of a video clip.

4. The method of claim 1, wherein the pane displaying the list of media content files displays metadata representing media characteristics of at least some of the media content files.

5. The method of claim 4, wherein the media characteristics of at least some of the media content files are derived from the content of the media content files.

6. The method of claim 1, comprising:
receiving, from a user of the media authoring application, a selection of a portion of a file system of a storage device; and
determining, based on characteristics of data files of the portion of the file system, if the portion of the file system contains media content supported by the media authoring application.

7. The method of claim 1 in which at least some of the media sources supported by the media authoring application are each associated with configuration data used by the media authoring application to access the respective media source.

8. A computer readable storage device encoded with instructions that, when executed by a computer system, cause a computer system to carry out operations comprising:
displaying, in a user interface of a media authoring application, an interface enabling a user of the media authoring application to import media content from any media source supported by the media authoring application, wherein at least one of the media sources is a media capture device and at least one of the media sources is a portion of a file system of a storage device, the interface including
a pane displaying a list of media sources currently available to the media authoring application,
a pane displaying a list of media content files available at a selected media source, and
a pane displaying at least a portion of a selected media content file.

9. The computer readable storage device of claim 8, wherein the portion of the selected media content file is a single frame of a video clip.

10. The computer readable storage device of claim 8, wherein the portion of the selected media content file is a series of frames of a video clip.

11. The computer readable storage device of claim 8, wherein the pane displaying the list of media content files displays metadata representing media characteristics of at least some of the media content files.

12. The computer readable storage device of claim 11, wherein the media characteristics of at least some of the media content files are derived from the content of the media content files.

13. The computer readable storage device of claim 8, comprising:
receiving, from a user of the media authoring application, a selection of a portion of a file system of a storage device; and
determining, based on characteristics of data files of the portion of the file system, if the portion of the file system contains media content supported by the media authoring application.

14. The computer readable storage device of claim 8 in which at least some of the media sources supported by the media authoring application are each associated with configuration data used by the media authoring application to access the respective media source.

15. A system comprising:
a media capture device;
a storage device; and
a computer system configured to execute a media authoring application,
the media authoring application configured to display an interface enabling a user of the media authoring application to import media content from any media source supported by the media authoring application, wherein at least one of the media sources is the media capture device and at least one of the media sources is a portion of a file system of the storage device, the interface including
a pane displaying a list of media sources currently available to the media authoring application,
a pane displaying a list of media content files available at a selected media source, and
a pane displaying at least a portion of a selected media content file.

16. The system of claim 15, wherein the portion of the selected media content file is a single frame of a video clip.

17. The system of claim 15, wherein the portion of the selected media content file is a series of frames of a video clip.

18. The system of claim 15, wherein the pane displaying the list of media content files displays metadata representing media characteristics of at least some of the media content files.

19. The system of claim 18, wherein the media characteristics of at least some of the media content files are derived from the content of the media content files.

20. The system of claim 15, comprising:
receiving, from a user of the media authoring application, a selection of a portion of a file system of a storage device; and
determining, based on characteristics of data files of the portion of the file system, if the portion of the file system contains media content supported by the media authoring application.

21. The system of claim 15 in which at least some of the media sources supported by the media authoring application are each associated with configuration data used by the media authoring application to access the respective media source.
